(19) United States
(12) Patent Application Publication
(10) Pub. No.: US 2020/0166076 A1
(43) Pub. Date: May 28, 2020

(54) ROLLING BEARING ARRANGEMENT FOR A TRANSMISSION

(71) Applicant: Schaeffler Technologies AG & Co. KG, Herzogenaurach (DE)

(72) Inventors: Benedikt Neugebauer, Uchtelhausen (DE); Jens Heim, Bergrheinfeld (DE)

(73) Assignee: Schaeffler Technologies AG & Co. KG, Herzogenaurach (DE)

(21) Appl. No.: 16/612,940

(22) PCT Filed: Apr. 11, 2018
(86) PCT No.: PCT/DE2018/100332

§ 371 Date: Nov. 12, 2019

(30) Foreign Application Priority Data
May 30, 2017 (DE) 102017111745.8

(51) Int. Cl. F16C 19/52; F16C 19/38; G01L 5/00

(52) U.S. Cl. CPC F16C 19/522; F16C 19/386; F16C 2360/31; G01L 5/0019; F16C 2233/00; F16C 19/525

(57) ABSTRACT

A rolling bearing arrangement (1) for a transmission (2) of a wind turbine, including a rolling bearing (3) with an outer ring (4), an inner ring (5) and a plurality of rolling bodies (6) rolling between the outer ring (4) and the inner ring (5), the outer ring (4) and/or the inner ring (5) including at least one sensor element (9) for detecting and monitoring a state variable, the at least one sensor element (6) having a load measuring bolt (7) with at least one strain gauge (8) and being directly positioned in a force flow path of the state variable, the state variable being at least a bearing preload of the rolling bearing (3).

### CROSS-REFERENCE TO RELATED APPLICATIONS

This application is a 371 National Phase of PCT/DE2018/100332, filed Apr. 11, 2018, which claims the benefit of German Patent Application No. 10 2017 111 745.8, filed May 30, 2017, both of which are incorporated by reference herein as if fully set forth.

### BACKGROUND

The disclosure relates to a rolling bearing arrangement for a transmission that, in particular, is designed for a wind turbine, comprising a rolling bearing having an outer ring, an inner ring and a multiplicity of rolling bodies rolling between the outer ring and the inner ring, wherein the outer ring and/or the inner ring have/has at least one sensor element for sensing and monitoring a state variable. The disclosure additionally relates to a wind turbine having the aforementioned rolling bearing arrangement, and to the use of the rolling bearing arrangement in a wind turbine.

In the case of wind turbine transmissions, sensors, for measuring differing state variables such as, for example, vibrations, temperatures and rotational speeds, are used to monitor the state of transmission elements. The sensors are usually attached to easily accessible locations on the transmission housing, and are connected by cables to an evaluation unit, in which the signals undergo further processing.

Known from DE 10 2011 087 471 A1 is a component having a material recess, and having a material element that includes at least one sensor. The material element is force-fitted into the material recess, and closes off the material recess in a flush manner, at least on one side. The sensor is designed to measure the forces acting upon the component and, in particular, the measure the deformations of the component.

### SUMMARY

The object of the present disclosure consists in further developing a rolling bearing arrangement for a transmission.

This object is achieved by one or more of the features according to the disclosure. Advantageous developments are given by claims, the description and the figures.

A rolling bearing arrangement according to the disclosure for a transmission of a wind turbine comprises a rolling bearing having an outer ring, an inner ring and a multiplicity of rolling bodies rolling between the outer ring and the inner ring, wherein the outer ring and/or the inner ring have/has at least one sensor element for sensing and monitoring a state variable, wherein the at least one sensor element comprises a load measuring bolt having at least one strain gauge, wherein the at least one sensor element is positioned directly in a force flow path of the state variable, wherein the state variable is at least a bearing preload of the rolling bearing.

The load measuring bolt of the sensor element is preferably produced mechanically, and preferably made of a metallic material. The metallic material, in particular, has the same coefficient of expansion as the material of the inner ring and/or of the outer ring. The metallic material is therefore preferably a bearing steel. In addition, the load measuring bolt is realized, for example, in the form of a cylinder, with alternative geometries also being conceivable. The at least one strain gauge is, for example, adhesive-bonded onto a defined surface of the load measuring bolt or applied using a coating, the at least one strain gauge being arranged, for example, on an end face and/or a lateral face of the load measuring bolt. For example, temperature-induced resistance changes may be measured by a strain gauge arranged on the lateral face of the load measuring bolt. A strain gauge arranged on the end face of the load measuring bolt may measure, for example, strain-induced resistance changes caused by compression.

The rolling bearing arrangement according to the disclosure may alternatively also be provided for a main bearing assembly, in particular for a main bearing assembly of a shaft. The rolling bearing is realized, in particular, as a tapered-roller bearing. In addition, however, the rolling bearing may also be realized as a cylindrical-roller bearing, or other rolling bearing.

Permanent or intermittent sensing of the sensor measurement values of the load measuring bolts during operation makes it possible, for example, to deduce the currently existing preload of the rolling bearing arrangement. The sensor measurement values of the load measuring bolts are therefore a measure of the bearing preload. The bearing preload is sometimes an influence parameter for the service life of a rolling bearing. For example, by taking into account the actually prevailing bearing preload, a calculation of service life can be performed while the bearing is in operation, and a continuously updated prognosis of impending bearing damage can be effected.

The term force flow path describes the course of the preload force introduced into the bearing system of the rolling bearing arrangement, the preload force being generated, for example, by the tightening of a screw on the bearing ring. The preload force is supported on the housing of the transmission, the at least one sensor element being arranged radially on one of the preloaded components such as for example, the inner ring, the outer ring or an adjusting ring, in order to detect strain-induced resistance changes. The preload force may additionally be supported on the structure surrounding the rolling bearing arrangement, for example on a shaft or a bearing housing. Alternatively, the sensor element may be arranged on another preloaded component of the rolling bearing arrangement.

Preferably, the at least one sensor element is accommodated, at least partly, in a respective radial recess of the inner ring and/or of the outer ring. The recess is realized so as to complement the geometry of the load measuring bolt, such that a force-fitting and form-fitting connection is formed between the load measuring bolt, inserted into the recess, and the inner wall of the recess. Alternatively, the load measuring bolt may be cemented into the recess.

Preferably, the respective recess is realized on the inner circumferential surface of the inner ring. The simplified cable routing of the at least one strain gauge, to a signal processing device or to a receiver, for the purpose of communicating the measured data, is advantageous. The communication may be effected both by cable and wirelessly. In the case of wireless communication, the energy supply to the strain gauge may be effected, for example, by a rechargeable battery or so-called energy harvesting. For example, in the case of energy harvesting, energy is generated from vibrations, air flows, rotational energy, temperature differences or light. Alternatively, the energy supply may also be effected inductively or capacitively.

Furthermore, preferably, three recesses, having a respective sensor element accommodated therein, are realized in a uniformly distributed manner on a circumferential surface of the inner ring and/or of the outer ring. In other words, the recesses, with a respective sensor element accommodated therein, are realized in a uniformly distributed manner, at an angle of 120° in relation to each other, on the circumference of the inner ring and/or of the outer ring. In addition, it is also conceivable for more or fewer sensor elements to be arranged in a uniformly or non-uniformly distributed manner on the circumferential surface of the inner ring and/or of the outer ring.

In a further preferred embodiment, the at least one sensor element is arranged on an adjusting ring. Preferably, the adjusting ring has a respective radially realized recess, for at least partly receiving the at least one sensor element. The adjusting ring bears axially against the rolling bearing, in particular against the inner ring or the outer ring, and may be screw-connected to produce a preload force. The sensor element arranged in the adjusting ring may be used, for example, to measure and monitor the bearing preload force.

The disclosure includes the technical teaching that the at least one strain gauge is realized by a coating. In particular, the strain gauge is realized as a thin-film sensor, which is preferably protected by a protective layer, additionally applied to the strain gauge, against mechanical influences. The coating for realizing the strain gauge is processed, for example, using a laser.

Preferably, the outer ring and/or the inner ring have/has at least two sensor elements for temperature compensation. The temperature compensation is effected directly on the load measuring bolt. For example, the error caused by the effect of temperature can be precluded by arranging the strain gauges on the end face and on the lateral face of the load measuring bolt, and interconnecting the strain gauges in a half-bridge.

### BRIEF DESCRIPTION OF THE DRAWINGS

Two preferred exemplary embodiments of the disclosure are described in the following on the basis of the three drawings, in which elements that are the same or similar are denoted by the same reference numerals. Shown are:

FIG. 1 a simplified, schematic sectional representation of a partially represented transmission, having a device for sensing and monitoring a bearing system, according to a first exemplary embodiment,

FIG. 2 a schematic perspective representation of a sensor element according to the disclosure, and

FIG. 3 a simplified, schematic sectional representation of a partially represented transmission, having a device for sensing and monitoring a bearing system, according to a second exemplary embodiment.

### DETAILED DESCRIPTION

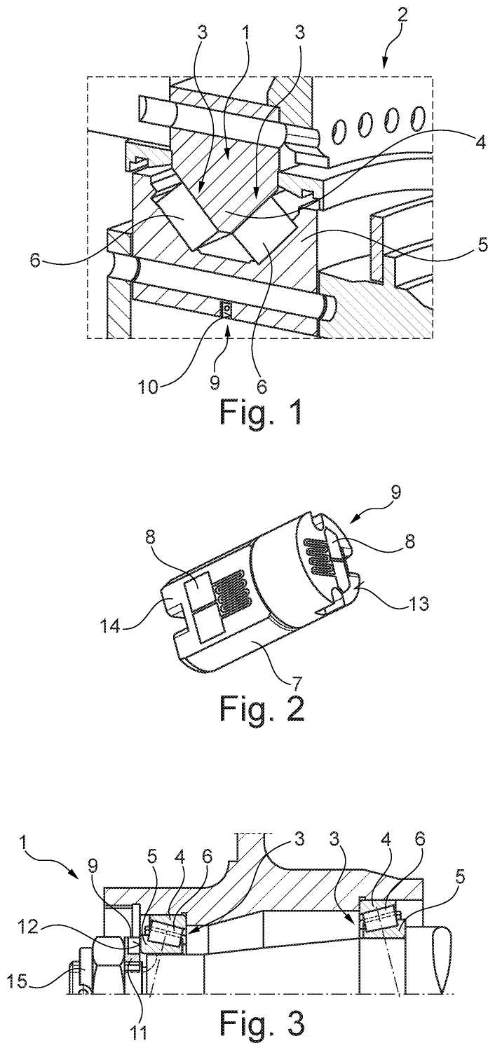

According to FIG. 1, a rolling bearing arrangement 1 according to the disclosure, according to a first embodiment, for a transmission of a wind turbine—not represented here—comprises a rolling bearing 3 having an outer ring 4, an inner ring 5 and a multiplicity of rolling bodies 6 rolling between the outer ring 4 and the inner ring 5. The inner ring 5 has a sensor element 9 for sensing and monitoring a state variable. The sensor element 9 is positioned directly in a force flow path of the state variable, the state variable being a preload force. The sensor element 9 is accommodated in a radial recess 10 of the inner ring 5, the recess 10 being realized on the inner circumferential surface of the inner ring 5. Alternatively or in addition, a sensor element 9 may also be arranged on the outer ring 4 of the rolling bearing 3, the sensor element 9 sensing the preload of the outer ring 4.

According to FIG. 2, the sensor element 9 comprises a load measuring bolt 7 having two strain gauges 8. The strain gauges 8 are thin-film sensors, and are realized as a coating on the load measuring bolt 7. The load measuring bolt 7 is realized in the form of a cylinder, the recess 10 represented in FIG. 1 being realized so as to complement the load measuring bolt 7. One of the two strain gauges 8 is arranged on an end face 13 of the load measuring bolt 7, the other strain gauge 8 being arranged on a circumferential surface 14 of the load measuring bolt 7.

Represented in FIG. 3 is a second embodiment of the rolling bearing arrangement 1, wherein the sensor element 9 is arranged on an adjusting ring 11, and wherein the sensor element 9 is inserted radially into a recess 12 of the adjusting ring 11. The adjusting ring 11 bears axially against the inner ring 5 of the rolling bearing 3, and is preloaded axially by a screw 15. Alternatively, the sensor element 9 may be used to measure a bearing preload in the rolling bearing 3, in particular on the inner ring 5 and/or on the outer ring 4.

The disclosure is not limited to the previously described exemplary embodiment. Further exemplary embodiments or development possibilities are given, in particular, by the claims or the description.

### LIST OF REFERENCE NUMBERS

1 rolling bearing arrangement
2 transmission
3 rolling bearing
4 outer ring
5 inner ring
6 rolling body
7 load measuring bolt
8 strain gauge
9 sensor element
10 recess
11 adjusting ring
12 recess
13 end face
14 circumferential surface
15 screw

1. A rolling bearing arrangement for a transmission of a wind turbine, the rolling bearing arrangement comprising:
a rolling bearing having an outer ring, an inner ring and a multiplicity of rolling bodies rolling between the outer ring and the inner ring;
at least one sensor element on at least one of the outer ring or the inner ring, the at least one sensor element being configured for sensing and monitoring a state variable, the at least one sensor element comprises a load measuring bolt having at least one strain gauge;
the at least one sensor element is positioned directly in a force flow path of the state variable, and the state variable is at least one bearing preload of the rolling bearing; and
the at least one sensor element is accommodated, at least partly, in a respective radial recess of the at least one of the inner ring or of the outer ring, or the at least one sensor element is arranged on an adjusting ring connected to the inner bearing ring or the outer bearing ring.

2. The rolling bearing arrangement as claimed in claim 1, wherein the respective recess is arranged on an inner circumferential surface of the inner ring.

3. The rolling bearing arrangement as claimed in claim 1, wherein the respective radial recess comprises three recesses, the at least one sensor element comprise three sensor elements, and a respective one of the sensor elements is accommodated in each of the recesses, and the recesses are realized in a uniformly distributed manner on a circumferential surface of the at least one of the inner ring or the outer ring.

4. The rolling bearing arrangement as claimed in claim 1, wherein the adjusting ring is provided and has a respective radially arranged recess that at least partly receives the at least one sensor element.

5. The rolling bearing arrangement as claimed in claim 1, wherein the at least one strain gauge comprises a coating.

6. The rolling bearing arrangement as claimed in claim 1, wherein the at least one sensor element comprises at least two of the sensor elements on the at least one of the outer ring or the inner ring configured for temperature compensation.

7. A wind turbine, comprising a rolling bearing arrangement as claimed in claim 1.

8. The rolling bearing arrangement as claimed in claim 1, wherein the at least one sensor comprises the bolt with one said strain gauge on a circumferential surface and one said strain gauge on an axial end surface thereof.

9. A wind turbine transmission rolling bearing arrangement, comprising:
a rolling bearing having an outer ring, an inner ring and a multiplicity of rolling bodies rolling between the outer ring and the inner ring;
at least one sensor element on at least one of the outer ring or the inner ring, the at least one sensor element being configured for sensing and monitoring a bearing preload and comprising a load measuring bolt having at least one strain gauge; and
the at least one sensor element is accommodated, at least partly, in a radial recess of the at least one of the inner ring or of the outer ring, or the at least one sensor element is arranged on an adjusting ring connected to the inner bearing ring or the outer bearing ring.

10. The bearing arrangement of claim 9, wherein the respective recess is arranged on an inner circumferential surface of the inner ring.

11. The bearing arrangement of claim 9, wherein the radial recess comprises three recesses, the at least one sensor element comprise three sensor elements, and a respective one of the sensor elements is accommodated in each of the recesses, and the recesses are arranged in a uniformly distributed manner on a circumferential surface of the at least one of the inner ring or the outer ring.

12. The bearing arrangement of claim 9, wherein the adjusting ring is provided and has a respective radially arranged recess that at least partly receives the at least one sensor element.

13. The bearing arrangement of claim 9, wherein the at least one strain gauge comprises a coating.

14. The bearing arrangement of claim 9, wherein the at least one sensor element comprises at least two of the sensor elements on the at least one of the outer ring or the inner ring configured for temperature compensation.

15. The bearing arrangement as claimed in claim 9, wherein the at least one sensor comprises the bolt with one said strain gauge on a circumferential surface and one said strain gauge on an axial end surface thereof.
